(19) United States
(12) Patent Application Publication
(10) Pub. No.: US 2011/0316872 A1
(43) Pub. Date: Dec. 29, 2011

(54) IMAGE DISPLAYING METHOD, DEVICE, AND RELATED LIQUID CRYSTAL DISPLAY PANEL

(76) Inventors: Hua Wu, Hsinchu County (TW); Ching-Chieh Wang, Yilan County (TW); Shang-Tzu Ju, Hsinchu City (TW)

(21) Appl. No.: 13/225,579

(22) Filed: Sep. 6, 2011

Related U.S. Application Data
(62) Division of application No. 12/014,102, filed on Jan. 15, 2008.

(51) Int. Cl. G09G 3/36; G09G 5/02

(52) U.S. Cl. 345/589; 345/102

(57) ABSTRACT

An image displaying method is provided. The image displaying method is utilized for displaying an image on a display region. The image has a first pixel and a second pixel respectively displayed on a first position and a second position in the display region. The image displaying method includes: deciding the first pixel according to a response time analysis, illuminating the first position and the second position according to a first brightness value of the first pixel; and adjusting brightness of the second position to a second brightness value of the second pixel.

### CROSS REFERENCE TO RELATED APPLICATIONS

This divisional application claims the benefit of co-pending U.S. patent application Ser. No. 12/014,102, filed on Jan. 15, 2008, and incorporated herein by reference.

### BACKGROUND

The present invention relates to an image displaying method, and more particularly, to an image displaying method, device, and related liquid crystal display panel.

Presently, liquid crystal display (LCD) panels are very popular display for TV, computer, and portable electronic devices to convey information to users. Cold cathode fluorescent lamps (CCFLs) are utilized to provide a backlight to illuminate the LCD panel, and a plurality of liquid crystal (LC) units are controlled to generate desired brightness. For example, in a twisted nematic device, the orientation of the liquid crystal units is parallel to the electrodes before an electric field is applied. When applying a voltage across the electrodes, a torque acts to align the liquid crystal units parallel to the electric field. By controlling the voltage applied across the liquid crystal layer in each pixel, light can be allowed to pass through in varying amounts, correspondingly illuminating the pixel.

Due to viscosity of LC units, a certain amount of time called “response time” is required to twist LC units to a desired orientation. Typically, normal response time is defined as the amount of time to change the brightness of a display region of the LCD from white (255) to black (0). However, transitions between gray values are more common in practice and take much longer response time than transitions from white to black, thereby causing undesired smears or blurs around moving objects.

It is desirable to design an improved image displaying method and device to compensate for the slow response of the liquid crystal feature, for example, an over driving circuit (ODC) renders a faster response time by providing a high driving voltage input greater than that of a normal type.

### SUMMARY OF THE INVENTION

One of the objectives of the present invention to provide an image displaying method, device, and related liquid crystal display to solve the above mentioned problem of long response time of liquid crystal units.

According to one embodiment, the present invention discloses an image displaying method for displaying an image on a display region, wherein the image comprises a first pixel and a second pixel respectively displayed on a first position and a second position in the display region. The image displaying method comprises: illuminating the first position and the second position according to a first brightness value (luminance value) of the first pixel; and adjusting brightness of the second position to a second brightness value of the second pixel.

According to another embodiment, the present invention discloses an image displaying device for displaying an image on a display region, wherein the image comprises a first pixel and a second pixel respectively displayed on a first position and a second position in the display region. The image displaying device comprises: an illuminating module, for illuminating the first position and the second position according to a first brightness value of the first pixel; and an adjusting module, coupled to the illuminating module, for adjusting brightness of the second position to a second brightness value of the second pixel.

According to still another embodiment, the present invention discloses a liquid crystal display (LCD) for displaying an image, comprising: at least a first display region and a second display region, displaying a first portion and a second portion of the image respectively, wherein each portion of the image comprises at least a first pixel and a second pixel respectively displayed on a first position and a second position in the corresponding display region; at least a first LED unit and a second LED unit, for illuminating the first display region and the second display region respectively, wherein each LED illuminates the first position and the second position in the corresponding display region according to a first brightness value of the first pixel in the corresponding portion of the image; a plurality of LC units, coupled to the first LED unit and the second LED unit; and a driving unit, coupled to the LC units, for twisting a corresponding LC unit to adjust brightness of the second position in the corresponding display region to a second brightness value of the second pixel in the corresponding portion of the image.

According to still another embodiment, the present invention discloses an exemplary image displaying method for displaying an image on a display region. The image comprises a first pixel displayed on a first position. The exemplary method includes illuminating the first position according to a first brightness value by an LED backlight; and adjusting brightness of the first position to a second brightness value by controlling a corresponding LC unit.

According to still another embodiment, the present invention discloses an image displaying device for displaying an image on a display region. The image comprises a first pixel displayed on a first position. The device includes an illuminating module for illuminating the first position according to a first brightness value, and an adjusting module, coupled to the illuminating module, for adjusting brightness of the first position to a second brightness value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an image displaying device according to an embodiment of the present invention.

FIG. 2 is a schematic diagram illustrating an image according to an embodiment of the present invention.

FIG. 3 is a flowchart illustrating an image displaying method according to an embodiment of the present invention.

FIG. 4 is a flowchart illustrating an image displaying method according to another embodiment of the present invention.

FIG. 5 is a flowchart illustrating an image displaying method according to yet another embodiment of the present invention.

### DETAILED DESCRIPTION

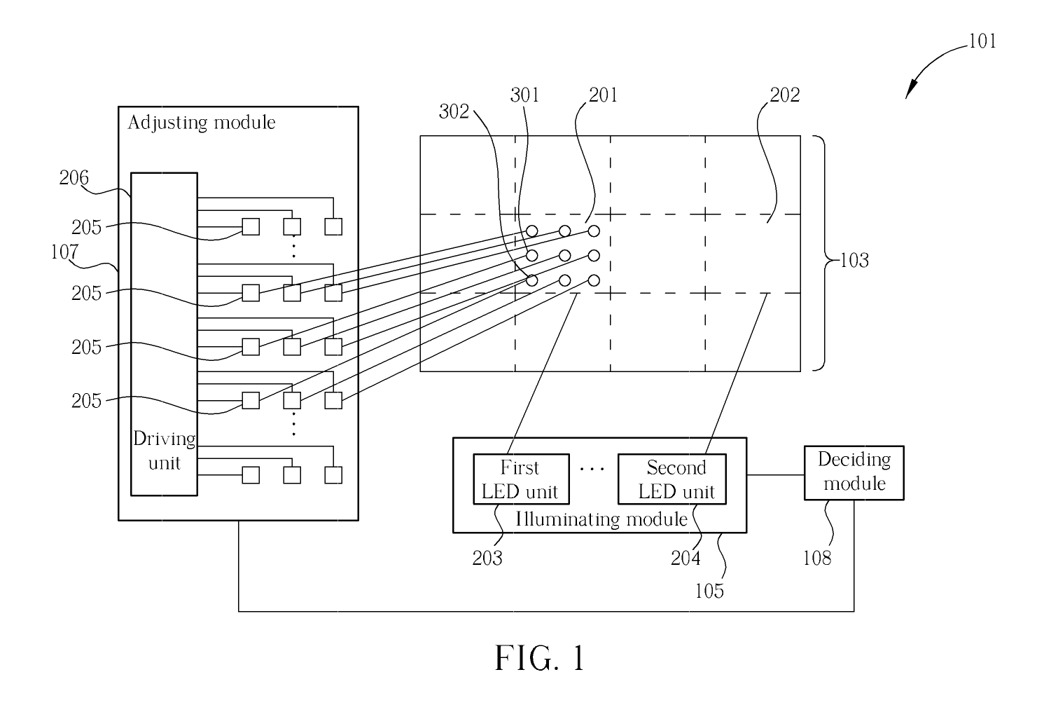

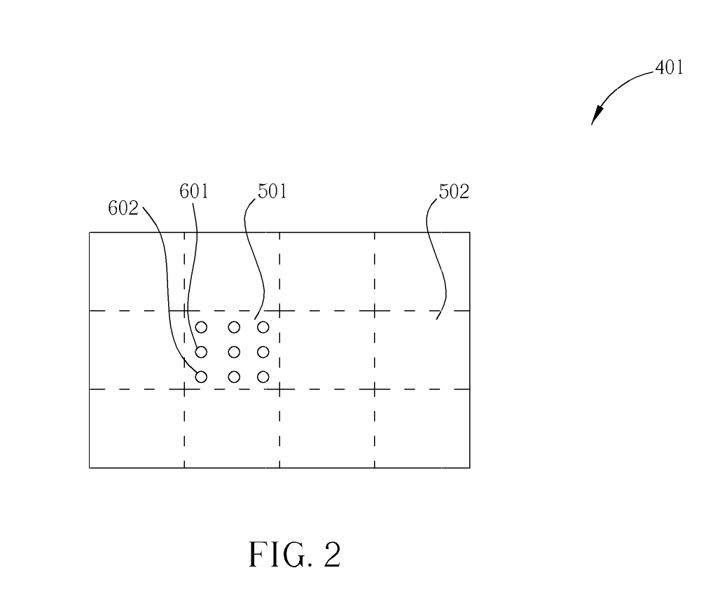

FIG. 1 is a schematic diagram illustrating an image displaying device 101 according to an embodiment of the present invention. FIG. 2 is a schematic diagram illustrating an image 401. Please refer to both FIGS. 1 and 2 for better understanding. In this embodiment, the image displaying device 101 is a liquid crystal display (LCD) panel comprising a display region 103, an illuminating module 105, an adjusting module 107, and a deciding module 108. The image displaying device 101 is utilized for displaying the image 401 on the display region 103. Furthermore, the display region 103 comprises at least a first display region 201 and a second display region 202 for displaying a first portion 501 and a second portion 502 of the image 401 respectively. Please note that, in the present invention, the first display region 201 and the second display region 202 are not required to have the same size, and the first portion 501 and the second portion 502 are not required to have the same size. In this embodiment, each portion of the image 401 comprises at least a pixel displayed on a position in the corresponding display region. For example, as shown in FIGS. 1 and 2, the first portion 501 of the image 401 comprises 3×3 pixels (i.e. 9 pixels) including the first pixel 601 and the second pixel 602 respectively displayed on the first position 301 and the second position 302 in the first display region 201. Please note that the first pixel 601 and the second pixel 602 are not limited to be the two left lower pixels as shown in the first portion 501 in FIG. 2. Any other pixel in the first portion 501 can be selected to be the first pixel 601 or the second pixel 602 according to some other criteria. Additionally, the illuminating module 105 comprises at least a first light emitting diode (LED) unit 203 and a second LED unit 204, for illuminating the first display region 201 and the second display region 202 respectively. The adjusting module 107 is coupled to the deciding module 108, and comprises a plurality of liquid crystal (LC) units 205 and a driving unit 206. The LC units 205 correspond to all positions in the display region 103 in a one-to-one manner so each LC unit controls the luminance of one pixel unit. The driving unit 206 is coupled to the LC units 205. The deciding module 108 is coupled to the first LED unit 203 and the second LED unit 204 of the illuminating module 105.

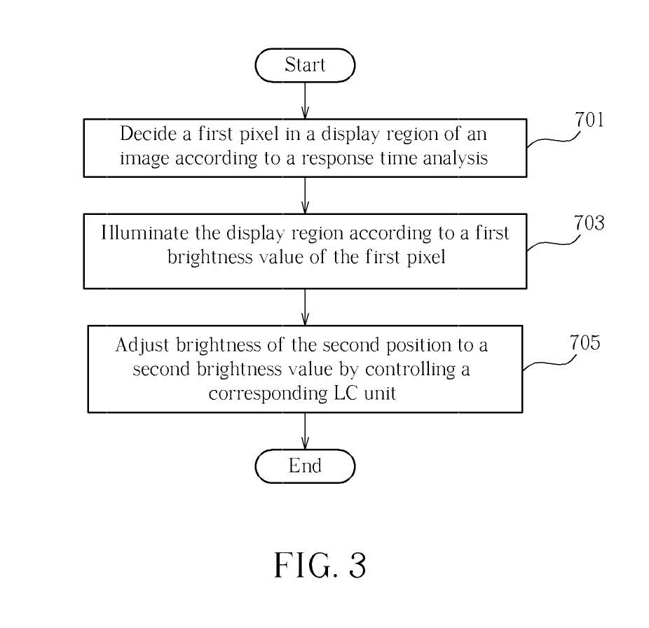

FIG. 3 is a flowchart illustrating an image displaying method according to an embodiment of the present invention. As shown in FIG. 3, the image displaying method comprises the following steps:

STEP 701: Decide a first pixel in a display region of an image according to a response time analysis;

STEP 703: Illuminate the display region according to a first brightness value of the first pixel; and

STEP 705: Adjust brightness of the second position to a second brightness value by controlling a corresponding LC unit.

First, the deciding module 108 decides the first pixel in each portion of the image 401 according to a response time analysis (STEP 701). Specifically speaking, the deciding module 108 decides a pixel in each portion of the image 401 corresponding to a longest response time as the first pixel. In this embodiment, suppose response time corresponding to the 9 pixels in the first portion 501 of the image 401 is 25, 40, 66, 40, 50, 40, 105, 25, and 30 milliseconds respectively. The deciding module 108 then decides the pixel corresponding to the longest response time (i.e. the pixel having the longest response time of 105 ms) as the first pixel 601 in the first portion 501 of the image 401. This example is not meant to be a limitation of the present invention. In some embodiments, the deciding module 108 has a built-in table which records the response time for each pixel value variation, and the pixel required the longest response time would be found by searching the table and comparing the response time.

Next, each LED unit illuminates a display region comprising a first position and a second position according to a first brightness value of the decided first pixel (STEP 703). In this embodiment, for the first portion 501 of the image 401, suppose the deciding module 108 determines the first pixel 601 requiring a longest response time among all the pixels in the first portion 501, and the brightness of the first pixel 601 is switching from 192 to 248. The first brightness value is thus 248, and the first LED unit 203 illuminates the first display region 201 to reach the first brightness value (e.g. 248).

Finally, the driving unit 206 controls corresponding LC units to display the desired brightness of each pixel in the display region considering the LED backlight illuminating the first brightness value (STEP 705). For example, suppose the second pixel 602 displayed in the first portion 501 is changing to a brightness value of 90. The driving unit 206 drives the corresponding LC unit 205 to make the overall brightness of the second position 302 equal to 90 with a backlight brightness of 248. The techniques as to how the driving unit 206 drives the LC units 205 to control quantity of light passing the LC units 205 are well known in the art, and thus the related description is omitted herein for brevity.

The control of LED units in STEP 703 and the control of individual LC units in STEP 705 can be performed at the same time once the first brightness is determined in STEP 701.

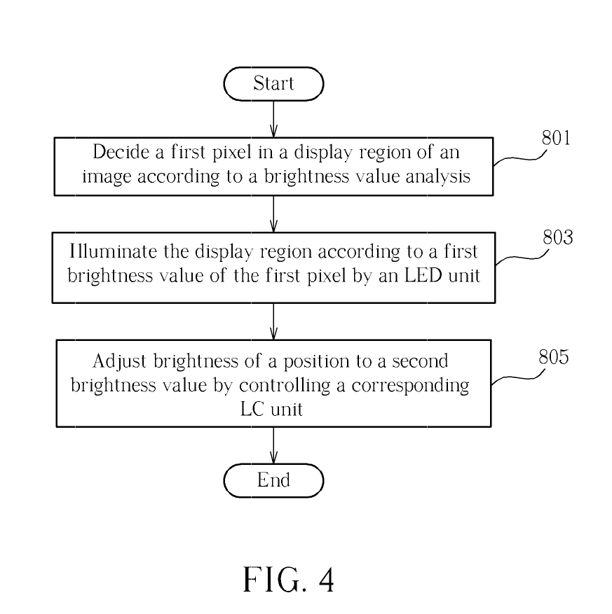

FIG. 4 is a flowchart illustrating an image displaying method according to another embodiment of the present invention. As shown in FIG. 4, the image displaying method comprises the following steps:

STEP 801: Decide a first pixel in a display region of an image according to a brightness value analysis;

STEP 803: Illuminate the display region according to a first brightness value of the first pixel by an LED unit; and

STEP 805: Adjust brightness of a position to a second brightness value by controlling a corresponding LC unit.

First, the deciding module 108 decides the first pixel in each portion of the image 401 according to a brightness value analysis (STEP 801). For example, the deciding module 108 decides a brightest pixel in each portion of the image 401 as the first pixel. In this embodiment, suppose the 9 pixels in the first portion 501 of the image 401 have brightness values of 60, 60, 80, 240, 20, 70, 60, 50, and 70 respectively. The deciding module 108 then decides the brightest pixel (i.e. the pixel having the brightness value of 240) as the first pixel 601 in the first portion 501 of the image 401. This example is not meant to be a limitation of the present invention, for example, a darkest pixel may be selected, or a pixel having a brightness value variation that is the greatest among the pixels in the same portion.

Next, each LED unit illuminates the display region comprising the first and second positions according to a first brightness value of the first pixel (STEP 803). For example, the first brightness value of the first pixel 601 is 240 in the first portion 501 of the image 401. The first LED unit 203 thus illuminates the first display region 201 utilizing the first brightness value (e.g. 240).

Finally, the driving unit 206 controls corresponding LC units to display the desired brightness of each pixel in the display region considering the LED backlight set to the first brightness value (e.g. 240) (STEP 805). For example, suppose the second pixel 602 displayed in the first portion 501 is changing to a brightness value of 80. The driving unit 206 then drives the corresponding LC unit 205 to make the overall brightness of the second position 302 equal to 80 with a backlight brightness of 240. The techniques as to how the driving unit 206 drives the LC units 205 to control quantity of light passing the LC units 205 are well known in the art, and thus the related description is omitted herein for brevity.

In an embodiment of the present invention, a display region of an image displaying device utilized for displaying an image can be divided into a plurality of small display regions, and each small display region thus displays a portion of the image. Additionally, an illuminating module of the image displaying device comprises a plurality of LED units, and each LED unit illuminates a small display region separately in a one-to-one manner. Since LEDs typically have response time of 50 nanoseconds, the image displaying device of the present invention can display images much faster and more clearly than conventional image displaying devices utilizing cold cathode fluorescent lamps (CCFLs) that have relatively high response time of 1˜2 seconds.

In an embodiment of the present invention, all positions in a small display region are illuminated utilizing a specific brightness value of a pixel corresponding to a longest response time in the corresponding portion of the image, and the brightness of other positions in the small display region can be adjusted to a desired brightness value of the corresponding pixel. The overall response time of the display region of the image displaying device can thus be greatly reduced due to that any position corresponding to the pixel corresponding to the longest response time is illuminated directly by the corresponding LED unit, and the brightness thereof is not required to be adjusted by the LC units any more.

In an embodiment of the present invention, all positions in a small display region are illuminated utilizing a specific brightness value of a brightest pixel in the corresponding portion of the image, and brightness of other positions in the small display region can be adjusted to a desired brightness value of the corresponding pixel. The overall light energy consumption of the display region of the image displaying device can thus be greatly reduced due to that the illuminating module of the image displaying device of the present invention is not necessarily required to illuminate the display region utilizing the maximum brightness value of 255 (i.e. white) as conventional image displaying devices always do.

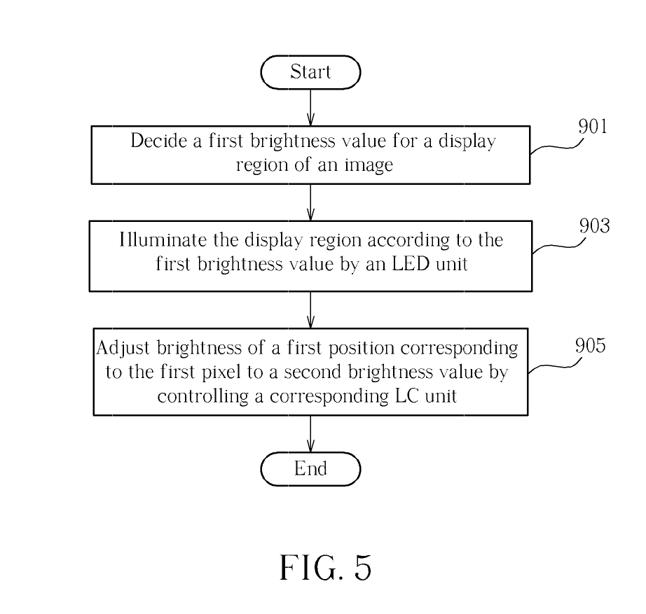

In above exemplary embodiments, each LED unit in the illuminating module 105 is capable of illuminating a corresponding display region according to a desired brightness value of a first pixel selected via a response time analysis or a brightness value analysis. In this way, the LC unit corresponding to the first pixel having longest response time or maximum brightness value is not required to further adjust the brightness of the first pixel after the display region is illuminated according to the desired brightness value of the first pixel. However, in a case where each LED unit in the illuminating module 105 only provides a limited number of available illumination levels, a display region including the first pixel selected by the deciding module 108 might not be exactly illustrated by the LED backlight according to the desired brightness value of the first pixel. Please refer to FIG. 5, which is a flowchart illustrating an image displaying method according to yet another embodiment of the present invention. As shown in FIG. 5, the image displaying method comprises the following steps:

STEP 901: Decide a first brightness value for a display region of an image;

STEP 903: Illuminate the display region according to the first brightness value by an LED unit; and

STEP 905: Adjust brightness of a first position corresponding to the first pixel to a second brightness value by controlling a corresponding LC unit.

In this alternative design of the present invention, the LC unit corresponding to the first pixel having longest response time or maximum brightness value is required to further adjust the brightness of the first pixel when the display region is illuminated according to a specific brightness value (i.e., a first brightness value) determined according to the desired brightness value of the first pixel (i.e., a second brightness value). For example, an illumination level, which is supported by the LED backlight and corresponds to a brightness value greater than and most close to the desired brightness value of the first pixel, is applied to the display region having the selected first pixel disposed therein. That is, the deciding module 108 decides the first pixel in each portion of the image 401 according to the aforementioned brightness value analysis or response time analysis (STEP 901). For instance, the first pixel 601 located at the first position 301 is selected by the deciding module 108. Next, each LED unit illuminates the display region comprising the first position according to a first brightness value determined according to available illumination levels supported by the LED units in the illuminating module 105 (STEP 903).

Finally, the driving unit 206 controls the LC units 205 corresponding to the first pixels in respective display regions, thereby making each first pixel display the desired brightness in the corresponding display region when the LED backlight is illuminating according to the first brightness value (STEP 905). For example, the first LED unit 203 illuminates the display region 201 according to the first brightness value. It should be noted that the first brightness value in this exemplary embodiment is not necessary to be equal to the desired brightness value of the selected first pixel. For example, the LED backlight is controlled to illuminate a limited number of illumination levels. However, with proper control of the LC unit corresponding to the first pixel (say, the first pixel 601 in FIG. 2), the overall brightness of the first position 301 in FIG. 1 is equal to the second brightness value being the desired brightness value of the first pixel under a backlight brightness of the first brightness value. Regarding the display of remaining pixels in the same display region illuminated according to the first brightness value, the driving unit 206 drives the corresponding LC units according to the same manner employed in the above-mentioned embodiments. In some embodiments, at least an LED unit in the illuminating module 105 is pixel controlled, which means the LED unit is responsible for illuminating only one pixel. The LED unit may be set to illuminate according to the desired brightness value of the corresponding pixel, or it may be set to illuminate with a first brightness value and using the LC unit to make the overall brightness equal the desired brightness value of the corresponding pixel. The techniques as to how the driving unit 206 drives the LC units 205 to control quantity of light passing the LC units 205 are well known in the art, and thus the related description is omitted herein for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image displaying method for displaying an image on a display region, wherein the image comprises a first pixel and a second pixel respectively displayed on a first position and a second position in the display region, the method comprising:
deciding the first pixel according to a response time analysis;
illuminating the display region according to a first brightness value of the first pixel by an LED backlight; and
adjusting brightness of the second position to a second brightness value of the second pixel by controlling a corresponding LC unit.

2. The method of claim 1, wherein the step of deciding the first pixel according to the response time analysis comprises:
deciding a pixel in the image corresponding to a longest response time as the first pixel by analyzing the pixel value variation.

3. An image displaying device for displaying an image on a display region, wherein the image comprises a first pixel and a second pixel respectively displayed on a first position and a second position in the display region, the device comprising:
a deciding module, for deciding the first pixel according to a response time analysis;
an illuminating module, coupled to the deciding module, for illuminating the display region according to a first brightness value of the first pixel; and
an adjusting module, coupled to the illuminating module, for adjusting brightness of the second position to a second brightness value of the second pixel.

4. The device of claim 3, wherein the deciding module decides a pixel in the image corresponding to a longest response time as the first pixel.

5. The device of claim 3, wherein the illuminating module comprises a light emitting diode (LED) unit.

6. The device of claim 3, wherein the adjusting module comprises:
a liquid crystal (LC) unit; and
a driving unit, coupled to the LC unit, for twisting the LC unit to adjust the brightness of the second position to the second brightness value.

7. A liquid crystal display (LCD) panel for displaying an image, comprising:
at least a first display region and a second display region, displaying a first portion and a second portion of the image respectively, wherein each portion of the image comprises at least a first pixel and a second pixel respectively displayed on a first position and a second position in the corresponding display region;
a deciding module, for deciding the first pixel in each portion of the image according to a response time analysis;
at least a first LED unit and a second LED unit, coupled to the deciding module, for illuminating the first display region and the second display region respectively, wherein each LED unit illuminates the corresponding display region according to a first brightness value of the first pixel in the corresponding portion of the image;
a plurality of LC units; and
a driving unit, coupled to the LC units, for twisting a corresponding LC unit to adjust brightness of the second position in the corresponding display region to a second brightness value of the second pixel in the corresponding portion of the image.

8. The LCD panel of claim 7, wherein the deciding module decides a pixel in each portion of the image corresponding to a longest response time as the first pixel.

9. An image displaying method for displaying an image on a display region, wherein the image comprises a first pixel displayed on a first position, the method comprising:
deciding the first pixel according to a response time analysis;
illuminating the first position according to a first brightness value by an LED backlight; and
adjusting brightness of the first position to a second brightness value by controlling a corresponding LC unit.

10. An image displaying device for displaying an image on a display region, wherein the image comprises a first pixel displayed on a first position, the device comprising:
a deciding module, for deciding the first pixel according to a response time analysis;
an illuminating module, coupled to the deciding module, for illuminating the first position according to a first brightness value; and
an adjusting module, coupled to the illuminating module, for adjusting brightness of the first position to a second brightness value.
